(19) United States
(12) Patent Application Publication
(10) Pub. No.: US 2005/0070827 A1
(43) Pub. Date: Mar. 31, 2005

(54) Cushion apparatus for recovery from fatigue

(76) Inventor: Kwang-Ho Lee, Kyonggi-do (KR)

Correspondence Address: NATTER & NATTER, 25 WEST 43 STREET, NEW YORK, NY, 10036, US

(21) Appl. No.: 10/812,472

(22) Filed: Mar. 31, 2004

(30) Foreign Application Priority Data
Sep. 29, 2003 (KR) 2003-67494
Oct. 31, 2003 (KR) 2003-77014

(51) Int. Cl. A61H 1/00

(52) U.S. Cl. 601/57; 601/70

(57) ABSTRACT

Disclosed herein is a cushion apparatus for recovery from fatigue. In accordance with the present invention, theft can be prevented during a sleep, the user can be waked up from sleep, the user can be made to recover from fatigue not only by the applying of vibration to the user's body using the vibration units but also by the applying of heat to the user's body using the heating wire, vibrational noise can be prevented, and the manufacturing process of the cushion apparatus can be simplified, thus improving the manufacturing yield of the cushion apparatus and reducing the manufacturing costs of the cushion apparatus.

### BACKGROUND OF THE INVENTION

1. Field of the Invention

The present invention relates generally to a cushion apparatus for recovery from fatigue and, more particularly, to a cushion apparatus for recovery from fatigue, which is capable of preventing theft, waking up a user, and allowing the user to recover from fatigue by applying both vibration, which is generated by a vibration unit, and heat, which is generated by a heating wire, to the user during rest or sleep.

2. Description of the Related Art

In general, the waist of a user is supported by a cushion to recover from fatigue or correct the posture of the user while the user is sitting on a sofa or chair. Such a cushion is generally manufactured by stuffing a sewn outer cover with cotton and sewing the mouth of the outer cover to prevent the cotton from being exposed to the outside of the outer cover. The cushion is used to support the waist of the user to allow the user to recover from fatigue and correct the posture of the user.

In the meantime, when a person sleeps in a stiff posture using only bedding for a long time, muscular pains may occur in the shoulder, waist or some other body part, so that the person cannot recover from fatigue and cannot have a deep sleep.

To overcome the above problems, the present applicant proposed a “cushion body containing vibration motors” filed on Jan. 11, 2002 (Korean Utility Model Appl. No 20-2002-00009591), issued on Apr. 22, 2002 and disclosed in Korean Utility Model Publication No. 20-0274179. The cushion body disclosed in Korean Utility Model Publication No. 20-0274179 includes a plurality of vibration motors enclosed in a cylindrical sponge having a certain length, an inner cover opened at one side thereof and configured to cover the sponge to be spaced apart therefrom, a buffer material interposed between the inner cover and the sponge, and a frame made of plastic and inserted into the open side of the inner cover at one end of the sponge to form a cylindrical appearance.

The frame includes a battery connected to the vibration motors via an electric wire, an aromatic cover provided with a slide plate that has a plurality of holes and is selectively and slidably opened and closed, and an outer cover made of fabric and configured to be selective opened and closed on one side thereof to allow an aromatic to be inserted thereinto.

The conventional cushion body applies vibration, generated by the vibration motors, to a user's body while being embraced in the chest, or supporting the waist or the legs during rest or sleep.

To insert the vibration motors into the sponge, a worker manually forms motor containing cavities in the sponge and puts the vibration motors into the motor containing cavities.

In that case, when the vibration motors are inserted into the sponge, the motor containing cavities may be mistakenly formed to be larger than the vibration motors due to a human error. In this case, when the conventional cushion body is used with the vibration motors contained in the containing cavities, vibrational noise is generated by the operation of the vibration motors during the operation of the cushion body, thus preventing the user from taking rest or having a deep sleep. Furthermore, the vibration motors are moved during operation, so that the life span of the vibration motors may be reduced.

### SUMMARY OF THE INVENTION

Accordingly, the present invention has been made keeping in mind the above problems occurring in the prior art, and an object of the present invention is to provide a cushion apparatus for recovery from fatigue, which is capable of allowing a user to recover from fatigue by applying both vibration, which is generated by a vibration motor, and heat, which is generated by a heating wire, to the user during rest or sleep.

Another object of the present invention is to provide a cushion apparatus for recovery from fatigue, which is capable of preventing theft during sleep.

Another object of the present invention is to provide a cushion apparatus for recovery from fatigue, which is capable of waking up a user at a set time.

Another object of the present invention is to provide a cushion apparatus for recovery from fatigue, which does not generate vibrational noise during the operation of a vibration unit.

Another object of the present invention is to provide a cushion apparatus for recovery from fatigue, which is capable of making a manufacturing process simple, thus increasing the manufacturing efficiency thereof.

Another object of the present invention is to provide a cushion apparatus for recovery from fatigue, which has reduced manufacturing costs.

In order to accomplish the above object, the present invention provides a cushion apparatus for recovery from fatigue, including a controller for controlling the entire operation of the apparatus, an alarm unit for outputting an alarm through a speaker in response to a signal output from the microprocessor of the controller at a preset time, and counting the preset time and outputting a signal indicating the coming of the preset time to the microprocessor of the controller to output a vibration control signal to the vibration drive means of the controller and thus alarm a user, transmission units for transmitting a high frequency transmission signal through antennas when it is detected that a door is opened or an unfamiliar person trespasses, a reception unit for receiving the high frequency transmission signal from the transmission units and outputting the high frequency signal to the controller, an input means for allowing a user command to be input to the controller, a plurality of vibration units arranged at regular intervals to apply vibration to a human body when the reception unit receives the high frequency transmission signal from the transmission units, the user command is input from the input means, and the time set by the alarm unit has elapsed, a cylindrical cushion body composed of semi-cylindrical upper and lower cushion bodies, the upper and lower cushion parts being each provided with a plurality of containing depressions arranged along the center line of the flat surface thereof at regular intervals to accommodating the vibration units, a plurality of cutouts arranged between the containing depressions at regular intervals to reduce the weight thereof, and an holding recess formed at one end thereof, an adaptor accommodated in the holding recess to receive Alternating Current (AC) power, convert the AC power into Direct Current (DC) power, and apply the DC power as operating power to the controller, a heat plate for receiving the DC power from the adaptor and applying heat to the human body under the control of the controller, a display means for emitting light and indicating that the heating on/off switch and vibration on/off switch of the input means are turned on when the heating on/off switch and the vibration on/off switch are turned, an inner cover for covering the heating plate fixedly mounted on the outer surface of the cylindrical cushion body, an outer cover for covering the inner cover, an aromatic pouch detachably attached to one of two strings tying both openings of the outer cover, a plurality of casings for accommodating the vibration units not only to prevent the breakage and malfunction of the vibration units during operation and improve the durability of the vibrations units, and an anion emitting unit electrically connected to a jack provided in the input means to emit anions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically showing a cushion apparatus for recovery from fatigue according to an embodiment of the present invention;

FIG. 2 is a perspective view schematically showing a cylindrical cushion body composed of upper and lower cushion bodies;

FIG. 3 is an exploded perspective view showing the cylindrical cushion body of FIG. 2;

FIG. 4 is a perspective view showing a vibration motor and the casing thereof used in the cushion apparatus according to the embodiment of the present invention;

FIG. 5 is a longitudinal section taken along line A-A of FIG. 1;

FIG. 6 is a left-side view schematically showing a controller in which an input means and a display means are placed, used in the cushion apparatus according to the embodiment of the present invention;

FIG. 7 is a right-side view schematically showing an anion emission unit, an alarm setting unit and an alarm time display means used in the cushion apparatus according to the embodiment of the present invention;

FIG. 8 is a block diagram schematically showing the controller for controlling the cushion apparatus according to the embodiment of the present invention;

FIG. 9 is a block diagram schematically showing a transmission unit applied to the cushion apparatus according to the embodiment of the present invention;

FIG. 10 is a block diagram schematically showing a transmission unit applied to the cushion apparatus according to another embodiment of the present invention; and

FIG. 11 is a detailed circuit diagram showing the RF reception module of a reception unit applied to the cushion apparatus according to the embodiment of the present invention.

### DESCRIPTION OF THE PREFERRED EMBODIMENTS

Reference now should be made to the drawings, in which the same reference numerals are used throughout the different drawings to designate the same or similar components.

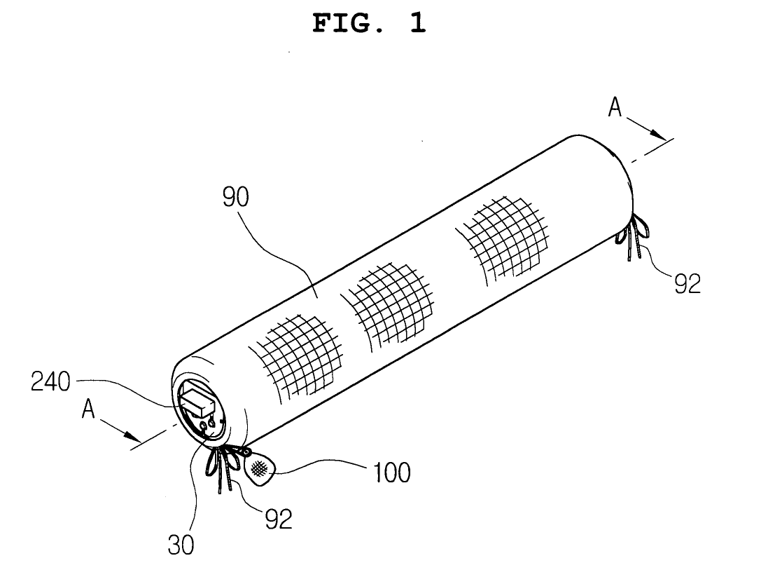

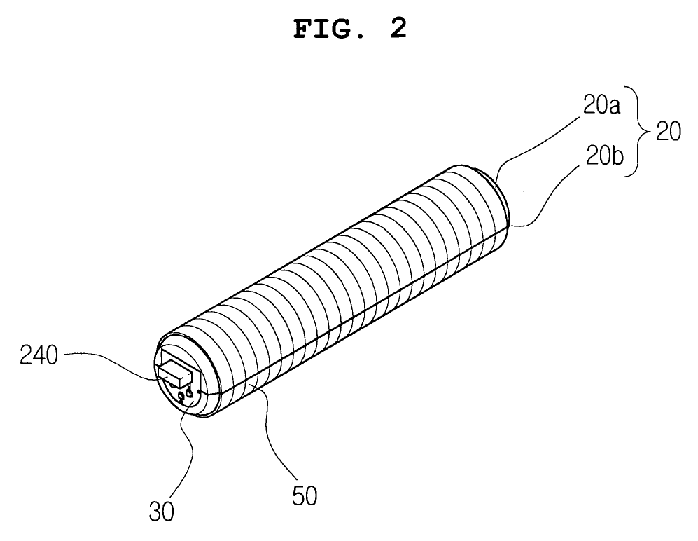

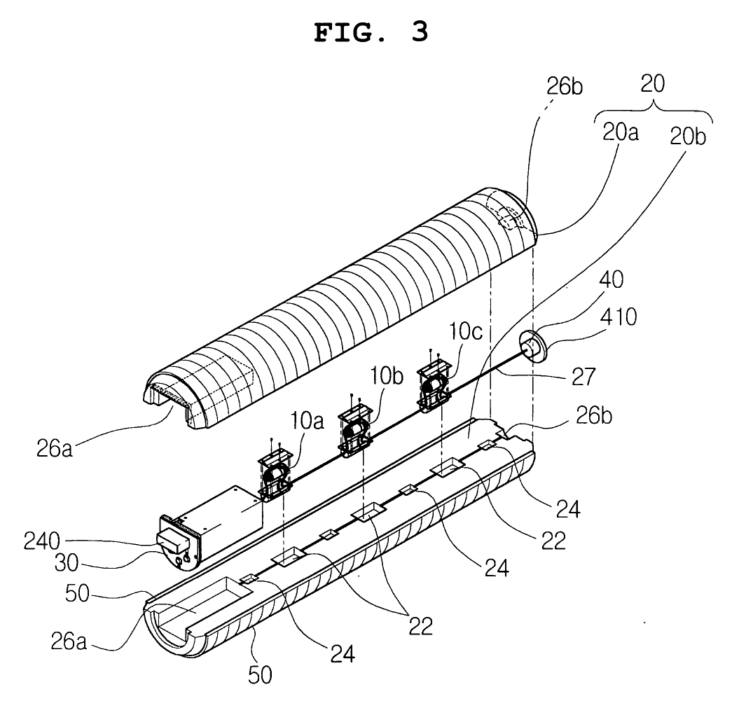

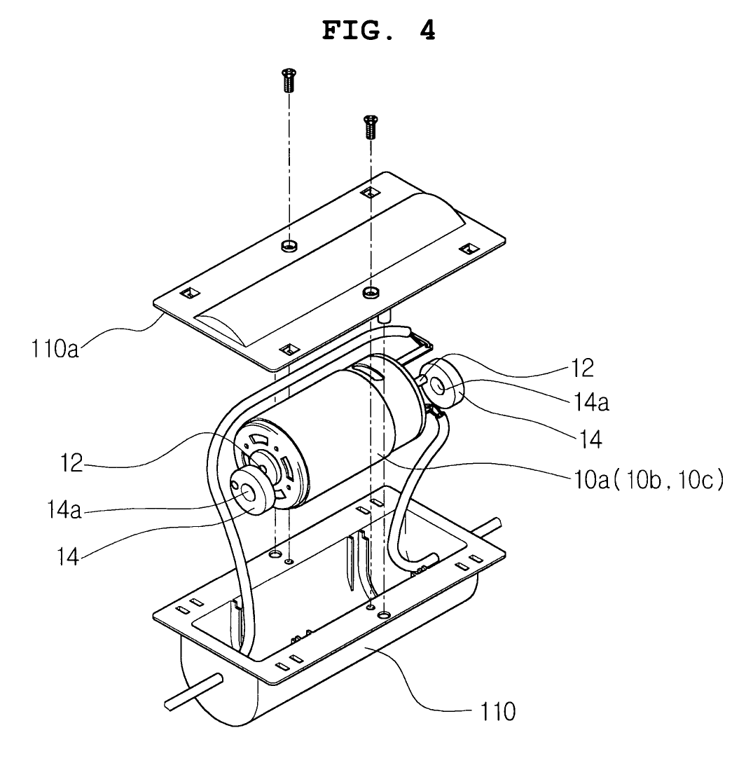

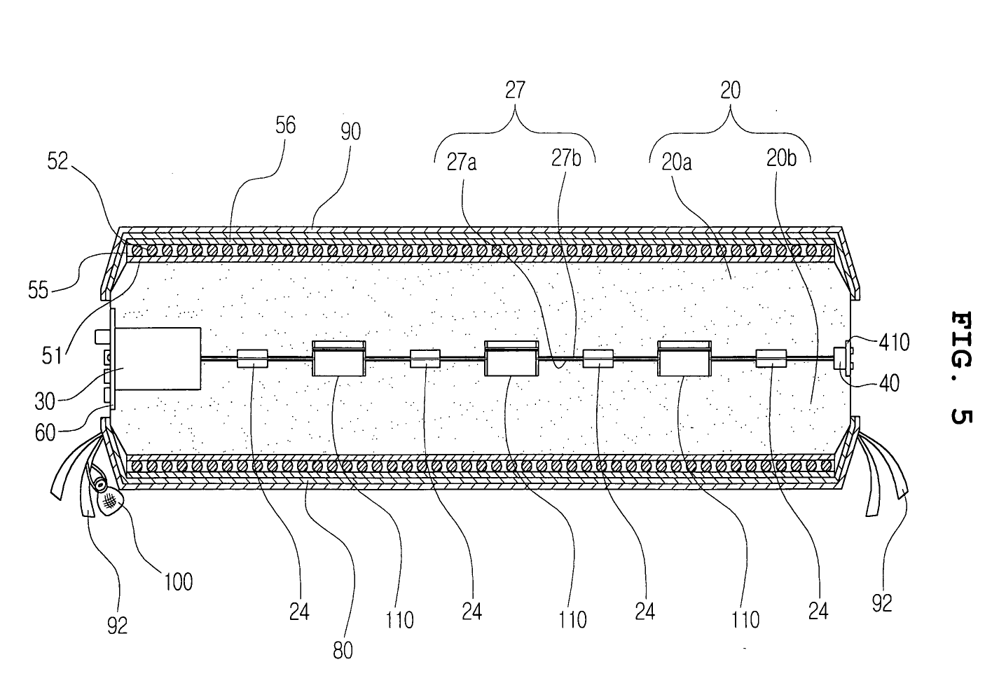

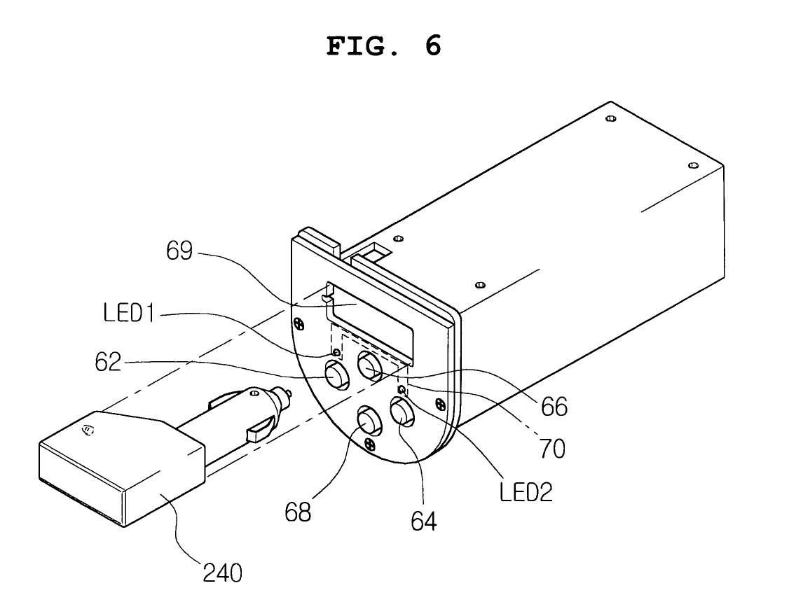

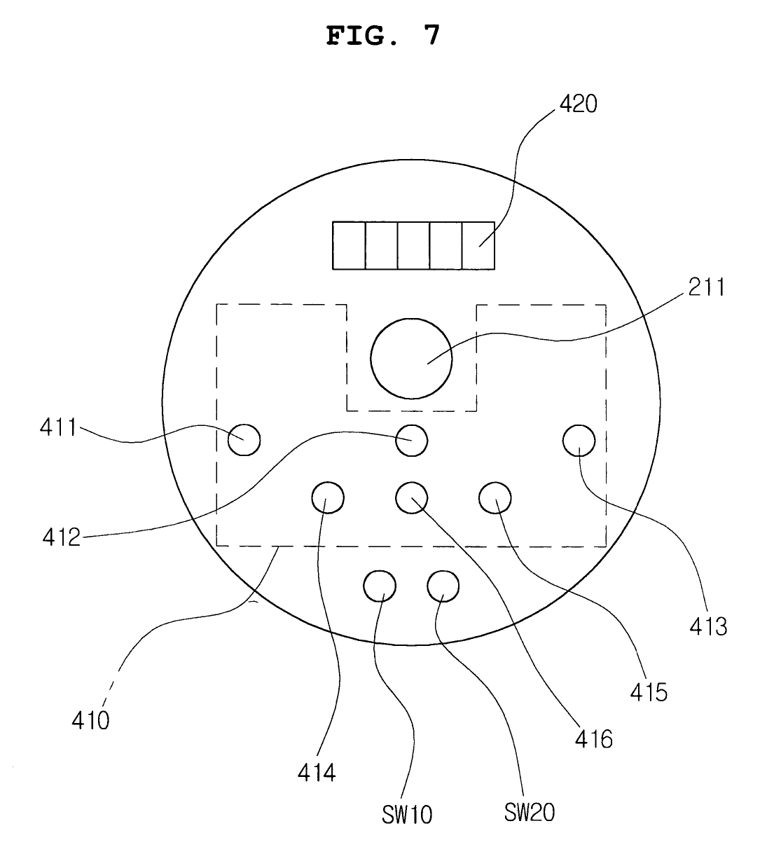

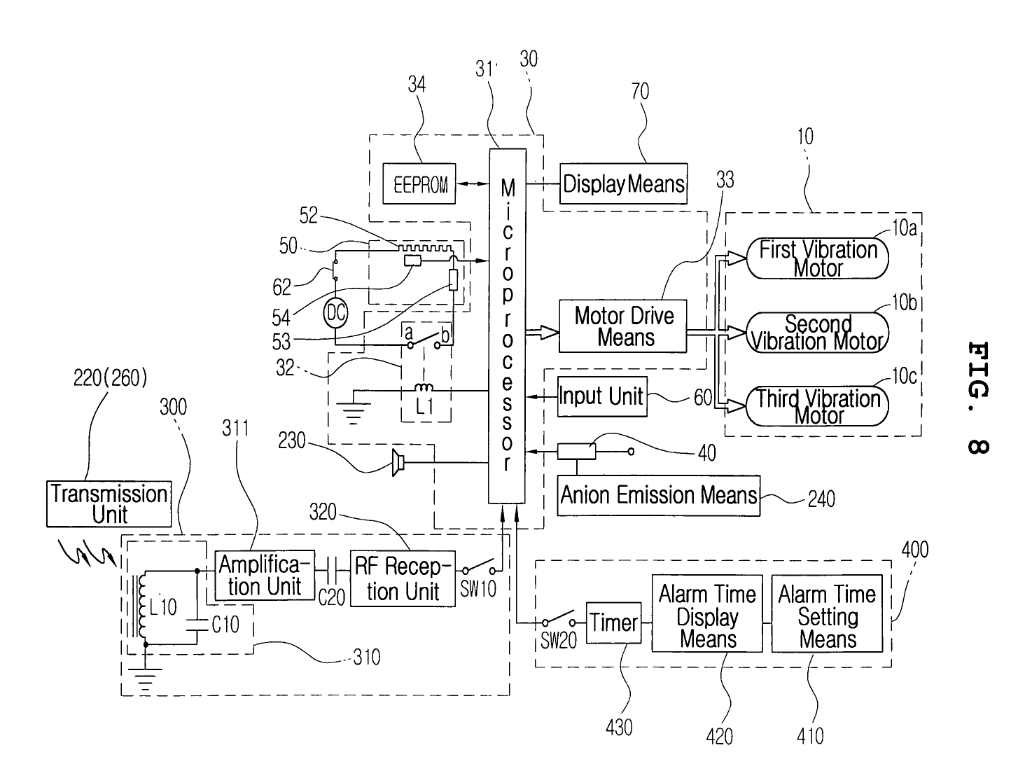

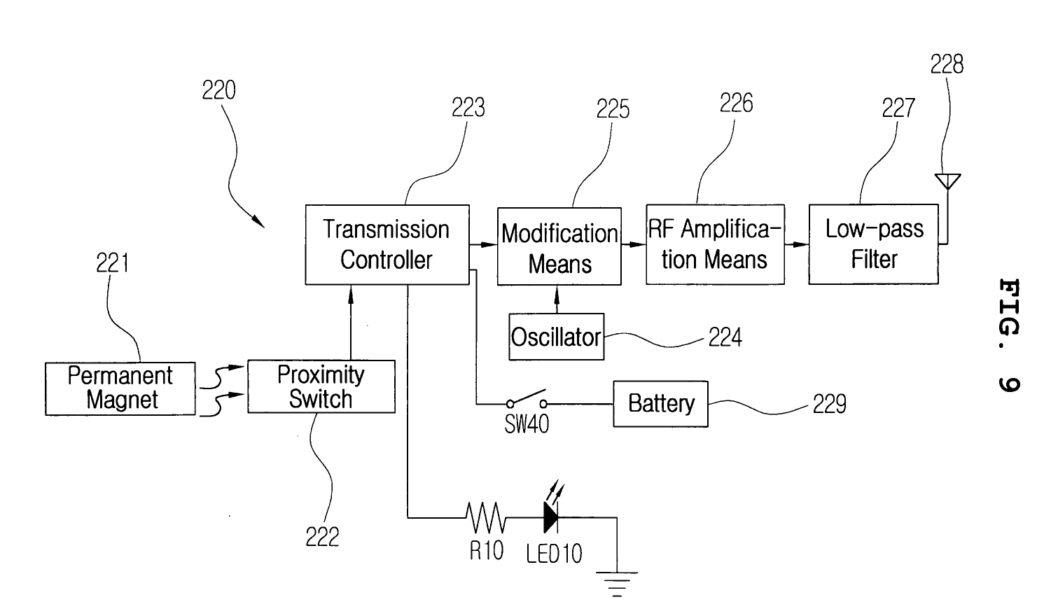

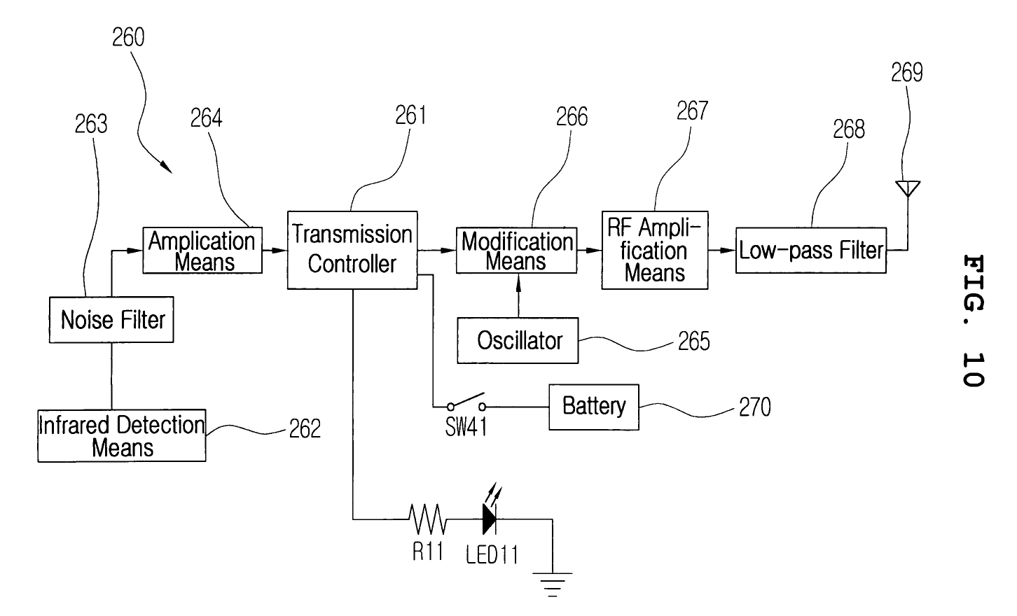

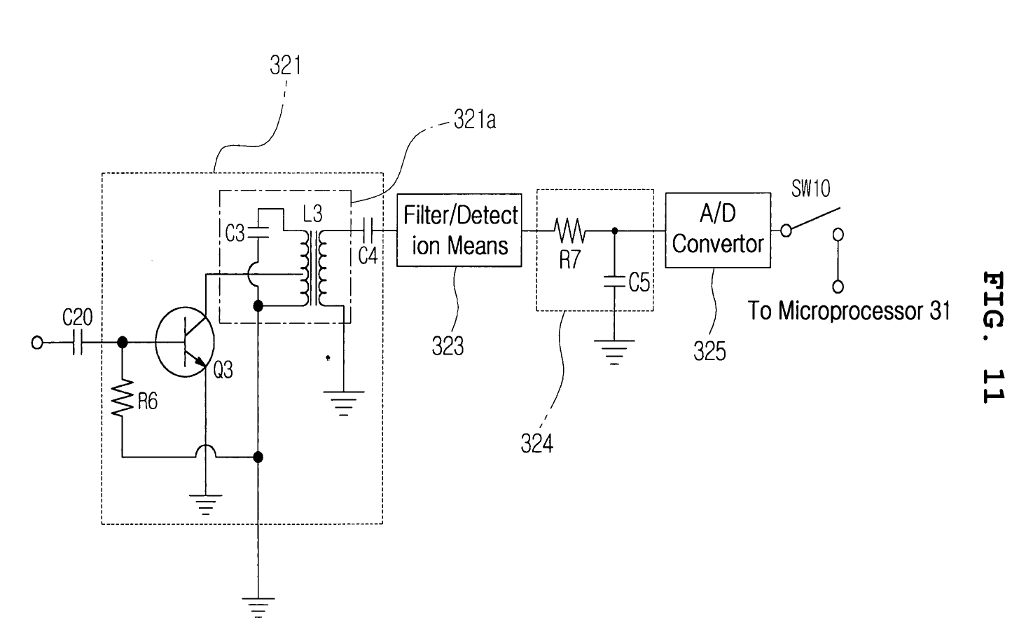

FIG. 1 is a perspective view schematically showing a cushion apparatus for recovery from fatigue according to an embodiment of the present invention. FIG. 2 is a perspective view schematically showing a cylindrical cushion body composed of upper and lower cushion bodies. FIG. 3 is an exploded perspective view showing the cylindrical cushion body of FIG. 2. FIG. 4 is a perspective view showing a vibration motor and the casing thereof used in the cushion apparatus according to the embodiment of the present invention. FIG. 5 is a longitudinal section taken along line A-A of FIG. 1. FIG. 6 is a left-side view schematically showing a controller in which an input means and a display means are placed, used in the cushion apparatus according to the embodiment of the present invention. FIG. 7 is a right-side view schematically showing an anion emission unit, an alarm setting unit and an alarm time display means used in the cushion apparatus according to the embodiment of the present invention. FIG. 8 is a block diagram schematically showing the controller for controlling the cushion apparatus according to the embodiment of the present invention. FIG. 9 is a block diagram schematically showing a transmission unit applied to the cushion apparatus according to the embodiment of the present invention. FIG. 10 is a block diagram schematically showing a transmission unit applied to the cushion apparatus according to another embodiment of the present invention. FIG. 11 is a detailed circuit diagram showing the RF reception module of a reception unit applied to the cushion apparatus according to the embodiment of the present invention.

As shown in FIGS. 1 to 11, a cushion apparatus for recovery from fatigue according to an embodiment of the present invention includes a controller 30 for controlling the entire operation of the apparatus, an alarm unit 400 for outputting an alarm through a speaker 230 in response to a signal output from the microprocessor 31 of the controller 30 at a preset time, and counting the preset time and outputting a signal indicating the coming of the preset time to the microprocessor of the controller 30 to output a vibration control signal to the vibration drive means 33 of the controller 30 and thus alarm a user, transmission units 220 and 260 for transmitting a high frequency transmission signal through antennas 228 and 269 when it is detected that a door is opened or an unfamiliar person trespasses, a reception unit 300 for receiving the high frequency transmission signal from the transmission units 220 and 260 and outputting the high frequency signal to the controller 30, an input means 60 for allowing a user command to be input to the controller 30, a plurality of vibration units arranged at regular intervals to apply vibration to a human body when the reception unit 300 receives the high frequency transmission signal from the transmission units 220 and 260, the user command is input from the input means 60, and the time set by the alarm unit 400 has elapsed, a cylindrical cushion body 30 comprised of semi-cylindrical upper and lower cushion bodies 20a and 20b, the upper and lower cushion parts 20a and 20b being each provided with a plurality of containing depressions 22 arranged along the center line of the flat surface thereof at regular intervals to accommodating the vibration units 10, a plurality of cutouts 24 arranged between the containing depressions 22 at regular intervals to reduce the weight thereof, and an holding recess 26b formed at one end thereof, an adaptor 40 accommodated in the holding recess 26b to receive Alternating Current (AC) power, convert the AC power into Direct Current (DC) power, and apply the DC power as operating power to the controller 30, a heat plate 50 for receiving the DC power from the adaptor 40 and applying heat to the human body under the control of the controller 30, a display means 70 for emitting light and indicating that the heating on/off switch 62 and vibration on/off switch 64 of the input means 60 are turned on when the heating on/off switch 62 and the vibration on/off switch 64 are turned, an inner cover 80 for covering the heating plate 50 fixedly mounted on the outer surface of the cylindrical cushion body 20, an outer cover 90 for covering the inner cover 80, an aromatic pouch 100 detachably attached to one of two strings 92 tying both openings of the outer cover 90, a plurality of casings 110 for accommodating the vibration units 10 not only to prevent the breakage and malfunction of the vibration units 10 during operation and improve the durability of the vibrations units 10, and an anion emitting unit 240 electrically connected to a jack 69 provided in the input means 60 to emit anions.

The vibration units 10 are preferably first to third vibration motors 10a, 10b and 10c arranged at regular intervals. Alternatively, the vibration units 10 may be a plurality of solenoids arranged at regular intervals.

After the first to third vibration motors 10a, 10b and 10c are placed in the casings 110, the openings of the casings 110 are preferably covered with lids 110a.

Two circular weights 14 are eccentrically attached to both ends of the rotating shaft 12 of each of the vibration units 10, which extends through the vibration units 10, to generate vibration.

The cushion body 20 is preferably formed of a sponge that is made by foaming and forming polyurethane.

The controller 30, as shown in FIG. 8, includes a microprocessor 31 for controlling the entire operation of the apparatus, a relay 32 configured to be switched to repeat the cycle, in which DC power is supplied to the heating wire 52 of the heating plate 50 for 60 minutes and the supply of DC power to the heating wire 52 is cut off for 1 minute, 10 times in response to a control signal output from the microprocessor 31 when the heating on/off switch 62 of the input means 60 is turned on, a vibration drive unit 33 for sequentially operating the vibration units 10 under the control of the microprocessor 31 to generate strong vibration when the reception unit 300 receives a high frequency transmission signal from the transmission units 220 and 260, a user command is input from the input means 60 or the time set by the alarm unit 400 has elapsed, and both the vibration on/off switch 64 of the input means 60 and a strong vibration switch 66 are turned on, and sequentially operating the vibration units 10 under the control of the microprocessor 31 to generate weak vibration when the reception unit 300 receives a high frequency transmission signal from the transmission units 220 and 260, a user command is input from the input means 60 or the time set by the alarm unit 400 has elapsed, and both the vibration on/off switch 64 of the input means 60 and a weak vibration switch 68 are turned on, and an Electrically Erasable Programmable Read-Only Memory (EEPROM) for strong an execution program operating the microprocessor 31.

The relay 32, as shown in FIG. 8, includes a relay coil L1 configured to be excited while passing a control signal output from the microprocessor 31, and movable and fixed contacts “a” and “b” configured so as to be closed to allow DC current to flow through the heating wire 52 of the heating plate 62 when the relay coil L1 is excited.

The heating plate 50 includes a bonding agent layer 51 applied to the cylindrical cushion body 20, a heating wire 52 placed on the bonding agent layer 51 to repeat a cycle, in which heat is emitted by the application of DC power for 1 hour and heat is not emitted for 1 minute 10 times, a bimetal 53 connected in the heating wire 52 to cut off the application of the DC power to the heating wire 52 when a temperature at a location adjacent to the heating wire 52 is higher than a predetermined temperature (for example, 60° C.), a temperature sensor 54 located at the location adjacent to the heating wire 52 to detect the temperature at the location and input information about the detected temperature to the microprocessor 31 of the controller 30, an insulation layer 55 adapted to coat the heating wire 52, the bimetal 53 and the temperature sensor 54, and a cover 56 configured to cover the insulation layer 55.

The input means 60 includes a heating on/off switch 62 for inputting a command to apply DC power to the heating wire 52 of the heating plate 50 to the microprocessor 31 of the controller 30, a vibration on/off switch 64 for inputting a user vibration control command to sequentially operate the vibration motors for a predetermined time to the microprocessor 31 of the controller 30, a strong vibration switch 66 for inputting a user strong vibration control command to operate the vibration units 10 to generate strong vibration, a weak vibration switch 68 for inputting a user weak vibration control command to operate the vibration units 10 to generate weak vibration, and a jack 69 for electrically connecting with the anion emission unit 240.

The display means 70 includes a first Light Emitting Diode (LED) LED1 configured to emit light when the heating on/off switch 62 of the input means 60 is turned on, and a second LED LED2 configured to emit light when the vibration on/off switch 64 of the input means 60 is turned on.

The alarm unit 400, as shown in FIG. 8, includes an alarm time setting means 410 for setting the alarm time after which an alarm sounds, an alarm time display means 420 for displaying the alarm time set by the alarm time setting means 410, a timer 430 for counting the set alarm time set by the alarm time setting means 410, and an alarm on/off switch SW20 for controlling the output of the counted alarm time to the controller 30.

The alarm time setting means 410, as shown in FIG. 7, includes the alarm time setting switch 412 for setting the alarm time after which a user is made to wake up, a hour changing switch 412 for changing hours to set the hours of the alarm time when the alarm time setting switch 411 is pressed, a minute changing switch 413 for changing minutes to set the minutes of the alarm time when the alarm time setting switch 411 is pressed, a hour/minute decreasing switch 415 for decreasing the hours and minutes of the set alarm time when the alarm time set by the alarm time setting switch 411, the hour changing switch 412 and the minute changing switch 413 is set to be later than a desired alarm time, a hour/minute increasing switch 415 for increasing the hours and minutes of the set alarm time when the set time changed by the minute/hour decreasing switch 415 is excessively decreased, and a reset switch 416 for resetting the alarm time set by the alarm time setting switch 411, the hour changing switch 412 and the minute changing switch 413 at the time of power failure.

The transmission unit 220, as shown in FIG. 9, includes a transmission controller 223 for controlling a transmission operation, a proximity switch 222 for detecting magnetic force lines output from the permanent magnet 221 mounted on a door frame and outputting a detection signal to the transmission controller 223, a modulation means 225 for receiving a transmission control signal from the transmission controller 223 and modulating the transmission control signal by combining the transmission control signal with a signal generated by an oscillator 224 into a carrier when the proximity switch 222 does not detect the magnetic force lines output from the permanent magnet 221, a Radio Frequency (RF) amplification means 226 for amplifying the carrier output from the modulation means 225 into a radio frequency signal, a low-pass filter 227 for filtering out a low-pass component from the radio frequency signal into which the carrier is amplified by the RF amplification means 226, a transmission antenna 228 for transmitting the radio frequency signal from which the low-pass component is filtered out, a battery 229 for supplying operating power to the transmission controller 223 when the switch SW40 is turned on, and a LED LED10 for indicating that the transmission controller 223 is operated.

The transmission unit 260, as shown in FIG. 10, includes a transmission controller 261 for controlling a transmission operation, an infrared ray detection means 262 for detecting an infrared signal emitted from a human body, a noise filter 263 for receiving the infrared signal detected by the infrared detection means 262 and filtering out noise from the infrared signal, an amplification means 264 for receiving the infrared signal from which the noise is filtered out by the noise filter 263, amplifying a noise-free infrared signal to a certain level, and outputting an amplified signal to the transmission controller 261, a modulation means 266 for receiving a transmission control signal from the transmission controller 261 and modulating the transmission control signal by combining the transmission control signal with a signal generated by an oscillator 265 into a carrier, an RF amplification means 267 for amplifying the carrier output from the amplification means 266 into a radio frequency signal, a low-pass filter 268 for filtering out a low-pass component from the radio frequency signal into which the carrier is amplified by the RF amplification means 267, a transmission antenna 269 for transmitting the radio frequency signal from which the low-pass component is filtered out, a battery 270 for supplying operating power to the transmission controller 261 when the switch SW41 is turned on, and a LED LED10 for indicating that the transmission controller 241 is operated.

The reception unit 300, as shown in FIG. 8, includes a reception antenna 310 composed of a resonant coil L10 wound on a ferrite core and a resonant condenser C10 connected in parallel to the resonant coil L10 to receive the radio signal transmitted from the antennas 228 and 269 and extract a resonant frequency signal from the radio signal, an amplification means 311 for amplifying the resonant frequency signal extracted by the reception antenna 310 to a certain level, a coupling condenser C20 for blocking the DC component signal of the resonant frequency signal and outputting only the AC component signal of the resonant frequency signal, an RF reception module 320 for amplifying the AC radio frequency signal output from the coupling condenser C20 to a certain level, performing filtering and detection and the AC radio frequency signal into a digital radio frequency signal, and a switch SW10 for controlling the output of the digital radio frequency signal to the microprocessor 31 of the controller 30.

The RF reception means 320, as shown in FIG. 11, includes a first amplification means 321 for filtering out a DC component signal included in the radio frequency signal received by the reception antenna 310 using the coupling condenser C20, amplifying an AC component signal to a certain level, and outputting only the AC component signal through accurate tuning to a reception frequency, a filter/detection means 323 for filtering out noise included in the AC component signal that is amplified into the certain level by the first amplification means 321, and detecting and outputting a noise-free AC component signal, an RC filter 324 composed of a resistor R7 and a capacitor C5 to filter out noise included in a detection signal output from the filter/detection means 323, and an A/D converter 325 for converting a noise-free detection signal into a digital signal.

The first amplification means 321 includes a transistor Q3 for blocking the DC component signal included in the radio frequency signal received by the reception antenna 310 using the coupling condenser C20, receiving only the AC component signal and amplifying the AC component signal to a certain level, a tank circuit 321a composed of a capacitor C3 and a coil L3 wound on a ferrite core to receive the reception signal amplified by the transistor Q3 and be accurately tuned to the reception frequency, and a coupling condenser C4 for blocking the AC component signal included in the reception signal output from the tank circuit 321a and outputting only the AC component signal to the filter/detection means 323.

In FIG. 7, reference numeral 211 designates a jack into which the plug (not shown) of the adaptor 40 is inserted.

The method of manufacturing the cushion apparatus for recovery from fatigue is described below. The casings 110 containing the vibration units 10 are enclosed in the containing depressions 22 formed in the upper and lower semi-cylindrical cushion bodies 20a and 20b constituting the cylindrical cushion body 20, as shown in FIG. 4. One of +lead wires 27a and 27b (27), which is electrically connected at the first ends thereof to the adaptor 40 contained in the accommodation recess 26b formed in one end of the cushion body 20, is connected in parallel to the connection terminals of the vibration units 10.

The other lead wire 27a or 27b is connected to the microprocessor 31 of the controller 30, and then is connected in parallel to the connection terminals of the vibration unit's 10 through the vibration drive units 33 that are electrically connected to the microprocessor 31.

In more detail, the casings 110 containing the vibration units 10 are enclosed in the containing depressions 22 that are formed in the semi-cylindrical cushion bodies 20a and 20b at regular intervals along the center lines of the flat surfaces of the semi-cylindrical cushion bodies 20a and 20b. The adaptor 40 is enclosed in the holding recess 26b that is formed at one end of the cylindrical cushion body 20. The controller 30 is enclosed in the holding recess 26b that is formed at the other end of the cylindrical cushion body 20. The plug (not shown) of the adaptor 40 is enclosed in the jack 211 so that the vibration units 10, the adaptor 40 and the controller 30 are electrically connected to each other. Thereafter, the cylindrical cushion body 20 is formed by applying a bonding agent to the flat surfaces of the semi-cylindrical upper and lower cushion bodies 20a and 20b and bonding the semi-cylindrical upper and lower cushion bodies 20a and 20b to each other.

Thereafter, when the heating plate 50 is bonded to the outer surface of the cylindrical cushion body 20 with a bonding agent layer interposed therebetween, not only is the heating plate 50 securely fastened to the outer surface of the cylindrical cushion body 20, but also the bonding agent layer 51, an insulation layer 55, the heating wire 52 and the cover 56 are sequentially stacked on the outer surface of the cylindrical cushion body 20.

After a slide fastener (not shown) longitudinally sewn on the inner cover 80 is opened, the cylindrical cushion body 20, to which the heating plate 50 is securely fastened, is put into the inner cover 20. When the cushion body 20 covered with the inner cover 80 is covered with the outer cover 90 and the strings 92 enclosed at both ends of the outer cover 90 are tightened, the input means 60 and the display means 70 of the controller 30 placed in the holding recess 26a are exposed at one side of the cushion body 20, so that the controller can be manipulated and, at the same time, the display means 70 can be seen, thus allowing a user to be aware of the operational status of the cushion apparatus for recovery from fatigue according to the present invention.

Simultaneously, since the adaptor 26b and the alarm time setting means 410 are placed in the holding recess 26b of the cushion body 20 and the alarm time setting means 410 is exposed at the other side of the cushion body 20, not only can alarm time be easily set by the alarm time setting means 410 but also the alarm time displayed by the alarm time display means 420 can be easily seen.

Accordingly, since the cushion apparatus of the present invention allows the heating plate 50 to be securely bonded to the cylindrical cushion body 20 with the bonding agent layer 51 interposed between the heating plate 51 and the outer surface of the cushion body 20, the manufacturing costs of the cushion apparatus can be reduced and the manufacturing yield of the cushion apparatus can be increased.

When the reception unit 300 receives a high frequency transmission signal from the transmission units 220 and 260, a user command is input from the input means 60 or the time set by the alarm unit 400 has elapsed, and the vibration on/off switch 64 of the input means 60 is turned on, the vibration units 10 are operated to generate weak vibration or strong vibration, thus allowing the user to recover from fatigue. Furthermore, when a set time has elapsed even during a deep sleep, the user wakes up from sleep by an alarm output from the speaker 230, and the user can wake up by the strong vibration or weak vibration of the vibration units 10, thus preventing theft.

The operation and effect of the cushion apparatus for recovery from fatigue according to an embodiment of the present invention is described below.

When AC voltage is applied to the adaptor 40 after the plug of the adaptor 40 is inserted into the jack 211, the adaptor 40 converts the AC voltage into the DC voltage and applies the DC voltage as operating power to the microprocessor 31 of the controller 30.

In that case, when the user turns on the heating on/off switch 62 of the input means 60, the microprocessor 31 performs an operation and repeats the cycle in which the microprocessor 31 outputs control signals to the relay coil L1 of the relay 32 for 60 minutes (variable) and cuts off control signals for 1 minute (variable) 10 times (variable). Accordingly, since the cycle, in which DC power is applied to the heating wire 52 by the electrical contact between the movable contact “a” and the fixed contact “b” of the relay 32 and the DC power is cut off for 1 minute, is repeated 10 times, heat is emitted from the heating wire 52 of the heating plate 50, and thus heat warms a human body.

In that case, when the temperature of the heating plate 50 exceeds 60° C., the bimetal 53 connected in the heating wire 52 is turned off (opened), the DC power is not applied to the heating wire 52 and thus the overheating of the heating plate 50 is prevented, thereby preventing the occurrence of a fire. Meanwhile, since a temperature sensor 54 located in the heating plate 50 detects temperature and continuously outputs detection signals to the microprocessor 31, the occurrence of a fire due to the overheating of the heating plate 50 can be prevented even during the failure of the bimetal 53.

When the user desires to recover from fatigue by applying strong vibration to his or her body while warming the body by applying the DC power to the heating wire 52 of the heating plate 50 and thus generating heat, or desires to recover from fatigue by applying strong vibration to his or her body without applying the DC power to the heating wire 52 of the heating plate 50, the vibration on/off switch 64 of the input means 60 of the controller 30 is pressed and the strong vibration switch 66 is pressed. Then, the microprocessor 31 of the controller 30 receives signals attributable to the pressing of the above switches 64 and 66, performs an operation based on the execution program stored in the EEPROM 34 and outputs strong vibration control signals to the vibration drive means 33. Consequently, strong vibration generated while the vibration units 10 are sequentially operated for a predetermined time (for example, 10 minutes, variable) is applied to the body, thus allowing the user to recover from fatigue.

In that case, if the user desires to extend the operating time of the vibration units 10, the user can press the vibration on/off switch 64 and the strong vibration switch 66 once more.

In the meantime, when the user desires to recover from fatigue by applying weak vibration to the body, the vibration on/off switch 64 of the input means 60 of the controller 30 and the weak vibration switch 68 are pressed. The microprocessor 31 of the controller 30 receives signals attributable to the pressing of the above switches 64 and 68, performs an operation based on the execution program stored in the EEPROM 34 and outputs weak vibration control signals to the vibration drive means 33 for a predetermined time (for example, 10 minutes; variable). Consequently, the vibration units 10 are sequentially operated in response to drive signals output from the vibration drive unit 33 to generate weak vibration and apply the weak vibration to the body, thus allowing the user to recover from fatigue.

In that case, if the user desires to extend the operating time of the vibration units 10, the user can press the vibration on/off switch 64 and the weak vibration switch 68 once more.

When the user desires to warm the body, to recover from fatigue by applying vibration to the body, and to purify the indoor air using anions, the anion emitting unit 240 is electrically connected to the jack 69 formed in the input means 60 by inserting the anion emitting unit 240 into the jack 69, and thus emits anions, thus purifying the indoor air.

In that case, when the heating on/off switch 62 placed in the input means 60 of the controller 30 is pressed, the first LED LED1 of the display means 70 emits light. Furthermore, when the vibration on/off switch 64 placed in the input means 60 of the controller 30 is pressed, the second LED LED2 of the display means 70 emits light.

Accordingly, the present invention allows the user to recover from fatigue not only by applying vibration to the body using the vibration units 10 but also by applying heat to the body using the heating wire 52 while allowing the user to smell aroma emitted from the aromatic pouch 100 during rest or sleep. Furthermore, the present invention prevents vibrational noise during the operation of the vibration units 10 and simplifies the manufacturing process of the cushion apparatus, thus improving the manufacturing yield of the cushion apparatus and reducing the manufacturing costs of the cushion apparatus.

Although the case where the vibration units 10 and the heating wire 52 of the heating plate 50 are operated by converting AC power into DC power using the adaptor 40 and applying the DC power to the vibration units 10 and the heating wire 52 of the heating plate 50 has been described as an example, the present invention is not limited to this case. For example, 12V DC power of the battery of an automobile can be employed to operate the vibration units 10 and the heating wire 52 by electrically connecting the vibration units 10 and the heating wire 52 to a cigar jack connected to the battery of the automobile.

When high frequency transmission signals are transmitted from the transmission units 220 and 260 (in the case where an unfamiliar person trespasses) while the switches SW40 and SW41 of the transmission units 220 and 260 and the switch SW10 of the reception unit 300 are turned on and the user sleeps while embracing the cushion apparatus of the present invention in his or her chest or holding the cushion apparatus of the present invention between his or her thighs, the transmission controllers 223 and 261 output transmission control signals to the modulation means 225 and 266, respectively, the modulation means 225 and 266 modulate the control signals into carriers by combining the transmission control signals with signals generated by the oscillators 224 and 265, respectively, and the RF amplification means 226 and 267 receive the carriers output from the modulation means 225 and 266, amplify the carriers into radio frequency signals and output the low-pass filters 227 and 268, respectively.

The low-pass filters 227 and 268 filter out low-pass components from the radio frequency signals, and transmit only high-pass radio frequency signals through the transmission antennas 228 and 269. At this time, as light emission control signals output from the transmission controllers 223 and 261 flow to the LEDs LED10 and LEDl1 through the current limiting resistors R10 and R11, respectively, the LEDs LED10 and LED1 emit light and thus indicates that the switches SW40 and SW41 are turned on, respectively (power is applied to the transmission controllers 223 and 261 from the batteries 229 and 270).

Accordingly, the radio frequency transmission signals transmitted through the transmission antenna 228 and 269 are received by the reception antenna 310 of the reception unit 300. Set resonant frequency signals are extracted from the received radio frequency transmission signals through the resonant coil L10 wound on a ferrite core and the resonant condenser connected in parallel to the resonant coil L10. The extracted resonant radio frequency signals are amplified to certain levels in the amplification means 311, respectively.

After DC component signals are filtered out from the resonant radio frequency signals amplified to certain levels in the amplification means 311, only AC component signals are output to the RF reception module 320. The AC component signals are amplified to certain levels in the transistor Q3 of the first amplification means 321 of the RF reception module 320. The received frequency signals amplified to certain levels in the transistor Q3 are accurately tuned to reception frequencies in the tank circuit 321a composed of the capacitor C3 and the coil L3 wound on the ferrite core. DC component received signals included in the received signals are blocked by the coupling condenser C4, and thus only AC component signals are output to the filter/detection means 323.

The filter/detection means 323 filters out noise included in the AC component reception signals amplified in the tank circuit 321a of the first amplification means 321 and performs detection. The RC filter 324 composed of the resistor R7 and the capacitor C5 filters out noise included in detection signals. The A/D converter 325 converts the signals into digital signals and outputs the digital signals to the microprocessor 31 of the controller 30.

Accordingly, the microprocessor 31 of the controller 30 outputs a vibration control signal to the vibration drive means 33. As a result, when the weak vibration switch 68 has been pressed, the vibration units 10 are operated and apply weak vibration to the user's body, and simultaneously an alarm is output from the speaker 230, thus waking up the user and preventing theft. When the strong vibration switch 66 has been pressed, the vibration units 10 are operated and apply strong vibration to the user's body, and simultaneously an alarm is output from the speaker 230, thus waking up the user and preventing theft.

In the meantime, if a certain time (for example, 3 hours, 6 hours or 8 hours) is set using the alarm time setting means 410 when the user desires to wake up after the elapse of the set time while sleeping with the cushion apparatus of the present invention embraced in his or her chest or the cushion apparatus of the present invention held between his or her thighs, the timer 430 of the alarm unit 400 counts the time, and outputs a time elapse signal to the microprocessor 31 of the controller 30 through the switch SW20 when the set time has elapsed. Accordingly, the microprocessor 31 outputs an alarm control signal to the speaker 230, and thus the speaker 230 outputs an alarm, so that the user can wake up after the set time. Furthermore, the microprocessor 31 of the controller 30 outputs a vibration control signal to the vibration drive means 33, and thus the vibration units 10 are operated and apply weak vibration to the user's body for a certain time (for example, 10 minutes; variable) when the weak vibration switch 68 has been pressed. In contrast, when the strong vibration switch 66 has been pressed, the vibration units 10 are operated and apply strong vibration to the user's body for a certain time (for example, 10 minutes, variable), thus allowing the user to wake up from a deep sleep and thus preventing theft.

To stop the output of the alarm, the switch SW20 is turned off. When the theft prevention function does not need to be performed, the switches SW40 and SW41 of the transmission units 220 and 260 or the switch SW10 of the reception unit 300 are turned off.

As a result, the present invention can prevent theft during a sleep, can wake the user up from sleep, can allow the user to recover from fatigue not only by applying vibration to the user's body using the vibration units 10 but also by applying heat to the user's body using the heating wire 52, can prevent vibrational noise, and can simplify the manufacturing process of the cushion apparatus, thus improving the manufacturing yield of the cushion apparatus and reducing the manufacturing costs of the cushion apparatus.

Although the case where the anion emission unit 240 emits anions while electrically connecting with the jack 69 formed in the input means 60 has been described as an example, the present invention is not limited to this case. For example, a mobile phone charger, a reading lamp and an electric razor can be used while connecting with the jack 69 formed in the input means 60.

As described above, since the present invention provides a cushion apparatus for recovery from fatigue, which includes a controller for controlling the entire operation of the apparatus, an alarm unit for outputting an alarm through a speaker in response to a signal output from the microprocessor of the controller at a preset time, and counting the preset time and outputting a signal indicating the coming of the preset time to the microprocessor of the controller to output a vibration control signal to the vibration drive means of the controller and thus alarm a user, transmission units for transmitting a high frequency transmission signal through antennas when it is detected that a door is opened or an unfamiliar person trespasses, a reception unit for receiving the high frequency transmission signal from the transmission units and outputting the high frequency signal to the controller, an input means for allowing a user command to be input to the controller, a plurality of vibration units arranged at regular intervals to apply vibration to a human body when the reception unit receives the high frequency transmission signal from the transmission units, the user command is input from the input means, and the time set by the alarm unit has elapsed, a cylindrical cushion body composed of semi-cylindrical upper and lower cushion bodies, the upper and lower cushion parts being each provided with a plurality of containing depressions arranged along the center line of the flat surface thereof at regular intervals to accommodating the vibration units, a plurality of cutouts arranged between the containing depressions at regular intervals to reduce the weight thereof, and an holding recess formed at one end thereof, an adaptor accommodated in the holding recess to receive Alternating Current (AC) power, convert the AC power into Direct Current (DC) power, and apply the DC power as operating power to the controller, a heat plate for receiving the DC power from the adaptor and applying heat to the human body under the control of the controller, a display means for emitting light and indicating that the heating on/off switch and vibration on/off switch of the input means are turned on when the heating on/off switch and the vibration on/off switch are turned, an inner cover for covering the heating plate fixedly mounted on the outer surface of the cylindrical cushion body, an outer cover for covering the inner cover, an aromatic pouch detachably attached to one of two strings tying both openings of the outer cover, a plurality of casings for accommodating the vibration units not only to prevent the breakage and malfunction of the vibration units during operation and improve the durability of the vibrations units, and an anion emitting unit electrically connected to a jack provided in the input means to emit anions, so that theft can be prevented during a sleep, the user can be waked up from sleep, the user can be made to recover from fatigue not only by the applying of vibration to the user's body using the vibration units but also by the applying of heat to the user's body using the heating wire, vibrational noise can be prevented, and the manufacturing process of the cushion apparatus can be simplified, thus improving the manufacturing yield of the cushion apparatus and reducing the manufacturing costs of the cushion apparatus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cushion apparatus for recovery from fatigue, comprising:
a controller for controlling the entire operation of the apparatus;
an alarm unit for outputting an alarm through a speaker in response to a signal output from the microprocessor of the controller at a preset time, and counting the preset time and outputting a signal indicating the coming of the preset time to the microprocessor of the controller to output a vibration control signal to the vibration drive means of the controller and thus alarm a user;
transmission units for transmitting a high frequency transmission signal through antennas when it is detected that a door is opened or an unfamiliar person trespasses;
a reception unit for receiving the high frequency transmission signal from the transmission units and outputting the high frequency signal to the controller;
input means for allowing a user command to be input to the controller;
a plurality of vibration units arranged at regular intervals to apply vibration to a human body when the reception unit receives the high frequency transmission signal from the transmission units, the user command is input from the input means, and the time set by the alarm unit has elapsed;
a cylindrical cushion body composed of semi-cylindrical upper and lower cushion bodies, the upper and lower cushion parts being each provided with a plurality of containing depressions arranged along the center line of the flat surface thereof at regular intervals to accommodating the vibration units, a plurality of cutouts arranged between the containing depressions at regular intervals to reduce the weight thereof, and an holding recess formed at one end thereof;
an adaptor accommodated in the holding recess to receive Alternating Current (AC) power, convert the AC power into Direct Current (DC) power, and apply the DC power as operating power to the controller;
a heat plate for receiving the DC power from the adaptor and applying heat to the human body under the control of the controller;
display means for emitting light and indicating that the heating on/off switch and vibration on/off switch of the input means are turned on when the heating on/off switch and the vibration on/off switch are turned;
an inner cover for covering the heating plate fixedly mounted on the outer surface of the cylindrical cushion body;
an outer cover for covering the inner cover;
an aromatic pouch detachably attached to one of two strings tying both openings of the outer cover;
a plurality of casings for accommodating the vibration units not only to prevent the breakage and malfunction of the vibration units during operation and improve the durability of the vibrations units; and
an anion emitting unit electrically connected to a jack provided in the input means to emit anions.

2. The cushion apparatus as set forth in claim 1, wherein the vibration units are first to third vibration motors arranged at regular intervals.

3. The cushion apparatus as set forth in claim 1, wherein the vibration units are a plurality of solenoids arranged at regular intervals.

4. The cushion apparatus as set forth in claim 1, wherein the controller comprises:
a microprocessor for controlling the entire operation of the apparatus;
a relay configured to be switched to repeat the cycle, in which DC power is supplied to the heating wire of the heating plate for 60 minutes and the supply of DC power to the heating wire is cut off for 1 minute, 10 times in response to a control signal output from the microprocessor when the heating on/off switch of the input means is turned on;
a vibration drive unit for sequentially operating the vibration units under the control of the microprocessor to generate strong vibration when the reception unit receives a high frequency transmission signal from the transmission units, a user command is input from the input means or the time set by the alarm unit has elapsed, and both the vibration on/off switch of the input means and a strong vibration switch are turned on, and sequentially operating the vibration units under the control of the microprocessor to generate weak vibration when the reception unit receives a high frequency transmission signal from the transmission units, a user command is input from the input means or the time set by the alarm unit has elapsed, and both the vibration on/off switch of the input means and a weak vibration switch are turned on; and
an Electrically Erasable Programmable Read-Only Memory (EEPROM) for strong an execution program operating the microprocessor.

5. The cushion apparatus as set forth in claim 1, wherein the heating plate comprises:
a bonding agent layer applied to the cylindrical cushion body;
a heating wire placed on the bonding agent layer to repeat a cycle, in which heat is emitted by the application of DC power for 1 hour and heat is not emitted for 1 minute, 10 times;
a bimetal connected in the heating wire to cut off the application of the DC power to the heating wire when a temperature at a location adjacent to the heating wire is higher than a predetermined temperature (for example, 60° C.);
a temperature sensor located at the location adjacent to the heating wire to detect the temperature at the location and input information about the detected temperature to the microprocessor of the controller;
an insulation layer adapted to coat the heating wire, the bimetal and the temperature sensor; and
a cover configured to cover the insulation layer.

6. The cushion apparatus as set forth in claim 1, wherein the input means comprises:
a heating on/off switch for inputting a command to apply DC power to the heating wire of the heating plate to the microprocessor of the controller;
a vibration on/off switch for inputting a user vibration control command to sequentially operate the vibration motors for a predetermined time to the microprocessor of the controller;
a strong vibration switch for inputting a user strong vibration control command to operate the vibration units to generate strong vibration;
a weak vibration switch for inputting a user weak vibration control command to operate the vibration units to generate weak vibration; and
a jack for electrically connecting with the anion emission unit.

7. The cushion apparatus as set forth in claim 1, wherein the alarm unit comprises:
alarm time setting means for setting the alarm time after which an alarm sounds;
alarm time display means for displaying the alarm time set by the alarm time setting means;
a timer for counting the set alarm time set by the alarm time setting means; and
an alarm on/off switch for controlling the output of the counted alarm time to the controller.

8. The cushion apparatus as set forth in claim 7, wherein the alarm time setting means comprises:
the alarm time setting switch for setting the alarm time after which a user is made to wake up;
a hour changing switch for changing hours to set the hours of the alarm time when the alarm time setting switch is pressed;
a minute changing switch for changing minutes to set the minutes of the alarm time when the alarm time setting switch 411 is pressed;
a hour/minute decreasing switch for decreasing the hours and minutes of the set alarm time when the alarm time set by the alarm time setting switch;
the hour changing switch and the minute changing switch is set to be later than a desired alarm time;
a hour/minute increasing switch for increasing the hours and minutes of the set alarm time when the set time changed by the minute/hour decreasing switch is excessively decreased; and
a reset switch for resetting the alarm time set by the alarm time setting switch, the hour changing switch and the minute changing switch at the time of power failure.

9. The cushion apparatus as set forth in claim 7, wherein the transmission unit comprises:
a transmission controller for controlling a transmission operation;
a proximity switch for detecting magnetic force lines output from the permanent magnet mounted on a door frame and outputting a detection signal to the transmission controller;
modulation means for receiving a transmission control signal from the transmission controller and modulating the transmission control signal by combining the transmission control signal with a signal generated by an oscillator into a carrier when the proximity switch does not detect the magnetic force lines output from the permanent magnet;
Radio Frequency (RF) amplification means for amplifying the carrier output from the amplification means into a radio frequency signal;
a low-pass filter for filtering out a low-pass component from the radio frequency signal into which the carrier is amplified by the RF amplification means;
a transmission antenna for transmitting the radio frequency signal from which the low-pass component is filtered out, a battery for supplying operating power to the transmission controller when the switch is turned on; and
a LED for indicating that the transmission controller is operated.

10. The cushion apparatus as set forth in claim 1, wherein the transmission unit comprises:
a transmission controller for controlling a transmission operation;
infrared ray detection means for detecting an infrared signal emitted from a human body;
a noise filter for receiving the infrared signal detected by the infrared detection means and filtering out noise from the infrared signal;
amplification means for receiving the infrared signal from which the noise is filtered out by the noise filter, amplifying a noise-free infrared signal to a certain level, and outputting an amplified signal to the transmission controller;
modulation means for receiving a transmission control signal from the transmission controller and modulating the transmission control signal by combining the transmission control signal with a signal generated by an oscillator into a carrier;
RF amplification means for amplifying the carrier output from the amplification means into a radio frequency signal;
a low-pass filter for filtering out a low-pass component from the radio frequency signal into which the carrier is amplified by the RF amplification means;
a transmission antenna for transmitting the radio frequency signal from which the low-pass component is filtered out;
a battery for supplying operating power to the transmission controller when the switch is turned on; and
a LED for indicating that the transmission controller is operated.

11. The cushion apparatus as set forth in claim 1, wherein the reception unit comprises:
a reception antenna composed of a resonant coil wound on a ferrite core and a resonant condenser connected in parallel to the resonant coil to receive the radio signal transmitted from the antennas and extract a resonant frequency signal from the radio signal;
amplification means for amplifying the resonant frequency signal extracted by the reception antenna to a certain level;
a coupling condenser for blocking the DC component signal of the resonant frequency signal and outputting only the AC component signal of the resonant frequency signal;
an RF reception module for amplifying the AC radio frequency signal output from the coupling condenser to a certain level, performing filtering and detection and the AC radio frequency signal into a digital radio frequency signal; and
a switch for controlling the output of the digital radio frequency signal to the microprocessor of the controller.

12. The cushion apparatus as set forth in claim 11, wherein the RF reception means comprises:
first amplification means for filtering out a DC component signal included in the radio frequency signal received by the reception antenna using the coupling condenser, amplifying an AC component signal to a certain level, and outputting only the AC component signal through accurate tuning to a reception frequency;
filter/detection means for filtering out noise included in the AC component signal that is amplified into the certain level by the first amplification means, and detecting and outputting a noise-free AC component signal;
an RC filter composed of a resistor and a capacitor to filter out noise included in a detection signal output from the filter/detection means; and
an A/D converter for converting a noise-free detection signal into a digital signal.

13. The cushion apparatus as set forth in claim 12, wherein the first amplification means comprises:
a transistor for blocking the DC component signal included in the radio frequency signal received by the reception antenna using the coupling condenser, receiving only the AC component signal and amplifying the AC component signal to a certain level;
a tank circuit composed of a capacitor and a coil wound on a ferrite core to receive the reception signal amplified by the transistor and be accurately tuned to the reception frequency; and
a coupling condenser for blocking the AC component signal included in the reception signal output from the tank circuit and outputting only the AC component signal to the filter/detection means.
